(19) United States
(12) Patent Application Publication
(10) Pub. No.: US 2024/0094554 A1
(43) Pub. Date: Mar. 21, 2024

(54) Control of reflections of a display device

(71) Applicant: RealD Spark, LLC, Boulder, CO (US)

(72) Inventors: Michael G. Robinson, BOULDER, CO (US); Graham J. Woodgate, Henley-on-Thames (GB)

(21) Appl. No.: 18/374,451

(22) Filed: Sep. 28, 2023

Related U.S. Application Data
(63) Continuation of application No. 17/114,098, filed on Dec. 7, 2020, now Pat. No. 11,796,828.
(60) Provisional application No. 62/946,297, filed on Dec. 10, 2019.

(51) Int. Cl. G02B 27/28; B60K 35/00; B60R 1/00

(52) U.S. Cl. CPC G02B 27/286; B60K 35/00; B60R 1/001; B60K 2370/37

(57) ABSTRACT

Reflections from a display device are controlled using retarders arranged on the output side of a display panel which outputs light with a predetermined polarization state. First and second planes of incidence are defined in respect of first and second rays of light output from the device and first and second normals to first and second surfaces of optically transmissive material at first and second points at which the first and second rays of light are reflected. The retarders are selected to cause the polarization state of the first ray to be linearly polarized in a direction that is in the first plane of incidence, and to cause the polarization state of the second ray to be linearly polarized in a direction that is in the second plane of incidence. The reflections from the surfaces are minimized because for both surfaces the polarization direction is in-plane.

### TECHNICAL FIELD

This disclosure generally relates to control of reflections of light output from a display device comprising a display panel.

### BACKGROUND

In many optical arrangements, reflections from surfaces of optically transmissive material, such as bare transparent windows, are a problem, particularly when viewed at night from an illuminated interior when significant reflections occur, giving a mirror appearance. While such reflections in houses are typically avoided by shades, such an option is not available in many optical arrangements, such as vehicles where reflections of bright internal displays can cause significant distraction.

One method to alleviate this issue is to introduce display devices with highly directional output. Such display devices would allow viewers, for example the driver and/or passengers in the case of a vehicle, to see an image displayed on the display device, while minimizing the light directed towards surfaces of optically transmissive material. However, such display devices typically require additional components and so are relatively expensive to manufacture.

The present disclosure is concerned with controlling such reflections from surfaces of optically transmissive material.

### BRIEF SUMMARY

According to a first aspect of the present disclosure, there is provided a method of controlling reflections of light output from a display device comprising a display panel arranged to output light that has a predetermined polarization state, the method using at least one optical retarder arranged on the output side of the display panel, the method comprising: defining a first plane of incidence in respect of a first ray of light output from the display device and a first normal to a first surface of optically transmissive material at a first point at which the first ray of light is reflected and a second plane of incidence in respect of a second ray of light output from the display device and a second normal to a second surface of optically transmissive material at a second point at which the second ray of light is reflected; and selecting the at least one optical retarder, in at least one mode of the at least one optical retarder, to cause the polarization state of the first ray of light to be linearly polarized in a direction that is in the first plane of incidence, and to cause the polarization state of the second ray of light to be linearly polarized in a direction that is in the second plane of incidence.

This method makes use of the reflection sensitivity of linearly polarized light resulting from Fresnel reflection at the surface. In particular, the reflectivity of a surface of optically transmissive material is lower for light that is linearly polarised in a direction in the plane of incidence (p-polarised light) than for light that is linearly polarised in a direction perpendicular to the plane of incidence (s-polarised light). The reflectivity of p-polarised light dips by a significant amount below the reflectivity of s-polarised light across most angles of incidence at the surface, reaching zero at some angles.

Most display panels output light that has a predetermined polarization state. For example, LCD (liquid crystal display) display devices are ubiquitous in vehicles as they deliver the high brightness levels required during daytime driving. Such LCD display devices function by modulating polarized light and provide linearly polarized output.

Also, this method uses the observation that a desired polarization state for a particular ray of a particular wavelength can always be transformed from any input polarization state with an arbitrary retarder whose optical axis and retardance are freely selected, and so it is possible to select optical retarders to independently control the polarisation state of two different rays of light output from a display device. This is undesirable in many optical arrangements where polarisation is used to provide a desired optical effect, but is an effect of the optical axis of the material of an optical retarder being aligned in a different direction with respect to each of the rays that is utilised to positive effect in this method.

Reflections of light from first and second surfaces of optically transmissive material are considered. Rays of light output from the display device and reflected from the first and second surfaces to a common viewing position are then defined. This permits definition of first and second planes of incidence in respect of the first and second rays of light and first and second normals to the first and second surfaces at first and second points at which the first and second rays of light are reflected. Thereafter, the at least one optical retarder is selected so that, in at least one mode of the at least one optical retarder, the polarization state of the first ray of light is caused to be linearly polarized in a direction that is in the first plane of incidence (i.e. p-polarised), and the polarization state of the second ray of light is also caused to be linearly polarized in a direction that is in the second plane of incidence (p-polarised). As a result, each ray of light is p-polarised with respect to reflection from its respective surface. This simultaneously minimises the amount of reflection from each surface compared to a situation in which the polarisation state is not so controlled and so some of the first and/or second rays of light may in general be, or at least include a component of, s-polarised light.

The selection of the at least one optical retarder may involve selection of the direction of the optical axis of the at least one optical retarder and the retardance of the at least one optical retarder to control the polarisation state of the two rays of light in the desired manner.

By way of example, one may consider the case of the optical arrangement being a vehicle containing an LCD display device mounted on the dashboard. The light output by the display device might advantageously be linearly polarized in a vertical direction to match the transmission of anti-glare polarized glasses when worn by a driver. In that case, the plane of incidence of a first ray of light reflected from the windshield is predominantly p-polarized with respect to the reflection geometry and so minimally reflected. This however is not the case for a second ray of light reflected from side windows, absent this method. That is, the second ray of light reflected from the side window is predominantly s-polarized and so the reflectivity is relatively high. However, with this method, the at least one optical retarder may causes the polarization state of the second ray of light to be transformed to be p-polarised, while maintain the p-polarisation of the first ray of light incident on the windshield, providing an elegant solution to the problem of reflection from the side windows.

According to a further aspect of the present disclosure, there is provided a display device comprising: a display panel arranged to output light that has a predetermined polarization state; and at least one optical retarder arranged on the output side of the display panel, wherein, defining a first plane of incidence in respect of a first ray of light output from the display device and a first normal to a first surface of optically transmissive material at a first point at which the first ray of light is reflected and a second plane of incidence in respect of a second ray of light output from the display device and a second normal to a second surface of optically transmissive material at a second point at which the second ray of light is reflected, the at least one optical retarder is selected, in at least one mode of the at least one optical retarder, to cause the polarization state of the first ray of light to be linearly polarized in a direction that is in the first plane of incidence, and to cause the polarization state of the second ray of light to be linearly polarized in a direction that is in the second plane of incidence.

Such a display device controls reflections in a similar manner to the first aspect of the present disclosure, as discussed above.

The display device may be incorporated in an optical arrangement that also comprises the first and second surfaces. Such an optical arrangement may be, for example, a vehicle, in which case the first and second surfaces may be surfaces of windows of the vehicle.

Embodiments of the present disclosure may be used in a variety of optical arrangements. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1, FIG. 2, and FIG. 3 are side perspective views of alternative constructions for a transmissive display device which controls reflections within an optical arrangement;

FIG. 4 is a front perspective view of the optical arrangement including the display device of FIGS. 1-3 and first and second surfaces;

FIG. 5 is a side view of reflections of linearly polarised light from surfaces of a sheet of optically transmissive material;

FIG. 6 is a graph of reflectivity of linearly polarised light from surfaces of a sheet of optically transmissive material;

FIG. 7 and FIG. 8 are perspective top views of the optical arrangement of FIG. 4 illustrating the rays in more detail;

FIG. 9 is a perspective view of an optical retarder showing an example of how the polarisation state of a ray of light is controlled;

FIG. 10 is a chart illustrating a method for selection of the optical retarders for output light having a predetermined polarization state of being linearly polarized in a direction in the first plane of incidence;

FIG. 11 is a chart illustrating a method for selection of the optical retarders for output light having an arbitrary predetermined polarization state:

FIG. 12 is a top view of an optical arrangement which is a vehicle including the display device and illustrating a reflection from a first surface which is the windscreen of the vehicle:

FIG. 13 is a side view of the vehicle shown in FIG. 12 illustrating the reflection from the first surface;

FIG. 14 is a view of the vehicle shown in FIG. 12 in the plane of incidence of the first ray reflected from the first surface:

FIG. 15 is a top view of the vehicle shown in FIG. 12 showing the reflection from a second surface which is a side window of the vehicle;

FIG. 16 is a side view of the vehicle shown in FIG. 15 illustrating the reflection from the second surface;

FIG. 17 is a view of the vehicle shown in FIG. 15 in the plane of incidence of the first ray reflected from the second surface;

FIG. 18 is a front view of a second example of the optical stack of the display device of FIG. 1 illustrating the polarization states of the rays of light;

FIG. 19 is a front view of a second example of the optical stack of the display device of FIG. 2 illustrating the polarization states of the rays of light;

FIG. 20 is a side perspective view of the display panel in the display devices of FIGS. 1-3;

FIG. 21, FIG. 22, and FIG. 23 are side perspective views of three alternative examples of an optical retarder in the display devices of FIGS. 1-3;

FIG. 24 is a side perspective view of the second optical retarder of FIG. 23:

FIG. 25 is a graph illustrating the variation of luminance with polar direction for the second optical retarder of FIG. 24 further comprising an illustrative analysing output polariser;

FIG. 26 is a perspective view of view angle control optical retarders that may be applied in the display panel of FIG. 1; and

FIG. 27 is a graph illustrating the variation of luminance with polar direction for the view angle control retarder of FIG. 26.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) are optically equivalent.

Optical axis refers to the direction of propagation of an unpolarised light ray in the uniaxial birefringent material in which no birefringence is experienced by the ray. For light propagating in a direction orthogonal to the optical axis, the optical axis is the slow axis when linearly polarized light with an electric vector direction parallel to the optical axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 450 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components; which is related to the birefringence Δn and the thickness d of the retarder by:

Γ=2·π·Δn.d/λ₀ eqn. 1

where Δn is defined as the difference between the extraordinary and the ordinary index of refraction, i.e.

Δn=nₑ−nₒ eqn. 2

Herein, a “half-wave retardance” of an optical retarder refers to the relationship between d, Δn, and λ₀ being chosen so that the phase shift between polarization components Γ is an odd multiple of π, that is π, 3π, 5π, etc. These values result in the optical retarder providing a transformation of light having a linearly polarised polarisation state into another linearly polarised polarisation state, rather than an elliptical polarisation state. To achieve this effect, then in general the relative phase shift Γ may be any odd multiple of π, although in practice it is often desirable to select the relative phase shift Γ to be π, as this reduces chromatic effects.

Such a half-wave retardance in general has a different value for light propagating along different rays of light which may be normal to the spatial light modulator or at an angle to the normal. Although it is common to define a retarder with respect to its retardance along the normal to the retarder, herein the methods are concerned with effects along different rays and so a half-wave retardance will be defined with respect to a given ray.

In the present disclosure an ‘A-plate’ refers to an optical retarder utilizing a layer of birefringent material with its optical axis parallel to the plane of the layer. The plane of the retarders refers to the slow axis of the retarders extend in a plane, that is the x-y plane.

A ‘positive A-plate’ refers to positively birefringent A-plates, i.e. A-plates with a positive Δn.

In the present disclosure a ‘C-plate’ refers to an optical retarder utilizing a layer of birefringent material with its optical axis perpendicular to the plane of the layer. A ‘positive C-plate’ refers to a positively birefringent C-plate, i.e. a C-plate with a positive Δn. A ‘negative C-plate’ refers to a negatively birefringent C-plate, i.e. a C-plate with a negative Δn.

In the present disclosure an ‘O-plate’ refers to an optical retarder utilizing a layer of birefringent material with its optical axis having a component parallel to the plane of the layer and a component perpendicular to the plane of the layer. A ‘positive O-plate’ refers to positively birefringent O-plates, i.e. O-plates with a positive Δn.

Achromatic retarders may be provided wherein the material of the retarder is provided with a retardance Δn−d that varies with wavelength λ as:

Δn·d/λ=κ eqn. 3

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees, such that there is an in-plane component that is small in magnitude relative to the component normal to the alignment layer.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

Transmissive spatial light modulators may further comprise retarders between the input display polariser and the output display polariser, for example as disclosed in U.S. Pat. No. 8,237,876, which is herein incorporated by reference in its entirety. Such retarders (not shown) are in a different place to the passive retarders of the present embodiments. Such retarders compensate for contrast degradations for off-axis viewing locations, which is a different effect to the luminance reduction for off-axis viewing positions of the present embodiments.

The structure and operation of various display devices will now be described. In this description, common elements have common reference numerals. It is noted that the disclosure relating to any element applies to each device in which the same or corresponding element is provided. Accordingly, for brevity such disclosure is not repeated.

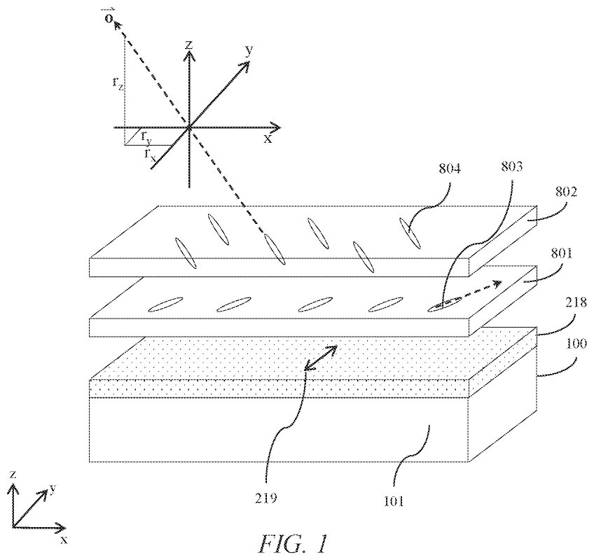

FIGS. 1-3 are side perspective views of alternative constructions of a display device 100 which controls reflections within an optical arrangement.

In each of FIGS. 1-3, the display device 100 includes a display panel 101. The display panel 101 includes output polariser 218 arranged on the output side of the display panel 101 so that the display panel 101 outputs light that has a predetermined polarization state of being linearly polarised. The direction of linear polarization corresponds to the electric vector transmission direction 219 of the output polariser 218. In the case of a ray of light along the normal to the plane of the output polariser 218, the direction of linear polarization is the same as the electric vector transmission direction 219. In the case of a ray of light at an acute angle to the normal to the plane of the output polariser 218, the direction of linear polarization is the projection of the electric vector transmission direction 219 onto a plane normal to the ray of light.

Provided that the output polariser 218 is present, the display panel 101 may be of a wide range of types, as discussed further below.

In each of FIGS. 1-3, reflections of light output from the display device 100 are controlled using at least one optical retarder arranged on the output side of the display panel 101, as follows.

In the examples of FIGS. 1 and 2, the at least one retarder comprises a first optical retarder 801 and a second optical retarder 802. The first optical retarder 801 comprises birefringent molecules 803, and has an optical axis parallel to the plane of the first optical retarder 801, so may be referred to as an A-plate. The second optical retarder 802 comprises birefringent molecules 804, and has an optical axis at an acute angle to the plane of the second optical retarder 802 in direction o, in at least a mode of operation of the second optical retarder 802, so may be referred to as an O-plate.

In general, the first optical retarder 801 and the second optical retarder 802 may be in either order with respect to the transmission of light from the display panel 101. Thus, in the example of FIG. 1 the first optical retarder 801 is arranged before the second optical retarder 802, whereas in the example of FIG. 2 the order is reversed so that the second optical retarder 802 is arranged before the first optical retarder 801.

Whereas the examples of examples of FIGS. 1 and 2 include two optical retarders, more generally any number of one or more optical retarders may be provided to provide the desired control of polarisation state of rays of light. In a simple example shown in FIG. 3 the first optical retarder 801 is omitted so that only the second optical retarder 802 is present. In other examples (not illustrated) more than two optical retarders may be provided.

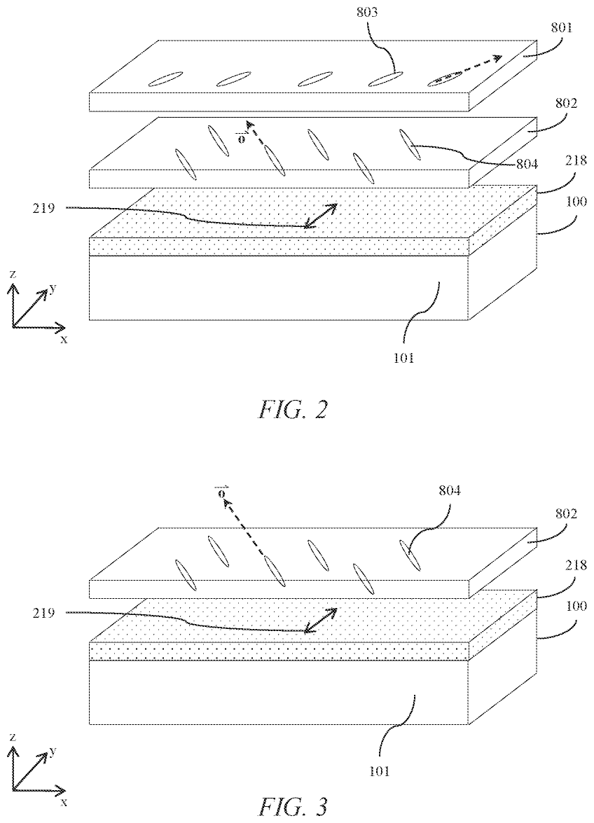

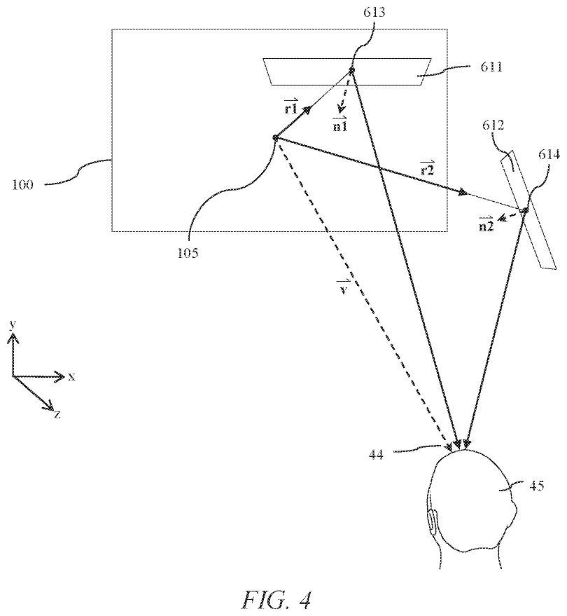

FIG. 4 is a front perspective view of the optical arrangement including the display device 100 of FIGS. 1-3, as well as a first surface 611 of optically transmissive material and a second surface 612 of optically transmissive material.

The display device 100 controls reflections from the first and second surfaces 611 and 612. The optical arrangement may be any type of optical arrangement including first and second surfaces 610 and 612 from which it is desired to control reflections. In one example, the optical arrangement may be a vehicle. In the case of a vehicle, the display device 100 may be any type of display device located within the vehicle, for example being an LCD, OLED or micro-LED display device or a simple instrument display device such as provided for illuminated switches. In the case of a vehicle, the first and second surfaces 610 and 612 may be surfaces of windows of the vehicle, for example the windshield and side windows.

The optically transmissive material may be any optically transmissive material from which Fresnel reflection occurs, non-limitative examples including glass and plastic.

FIG. 5 is a side view of reflections of linearly polarised light from surfaces 601 and 602 of a sheet of optically transmissive material 610.

The polarization of light relates to the time dependent direction of its oscillating electric field and can lie anywhere in the plane orthogonal to its propagation direction. If its direction remains constant while its amplitude oscillates sinusoidally it is said to have linear polarization which can be split into any two orthogonal components, each orthogonal to the propagation. For any given reflection surface there is a plane of incidence containing the surface normal vector n together with the incident ray ri and the reflected ray rr (in the plane of the drawing in FIG. 5). A polarization component of the incident ray ri that is perpendicular to the plane of incidence is called the s-polarization component s and polarization component of the incident ray ri that lies in the plane of incidence is called the p-polarization component p.

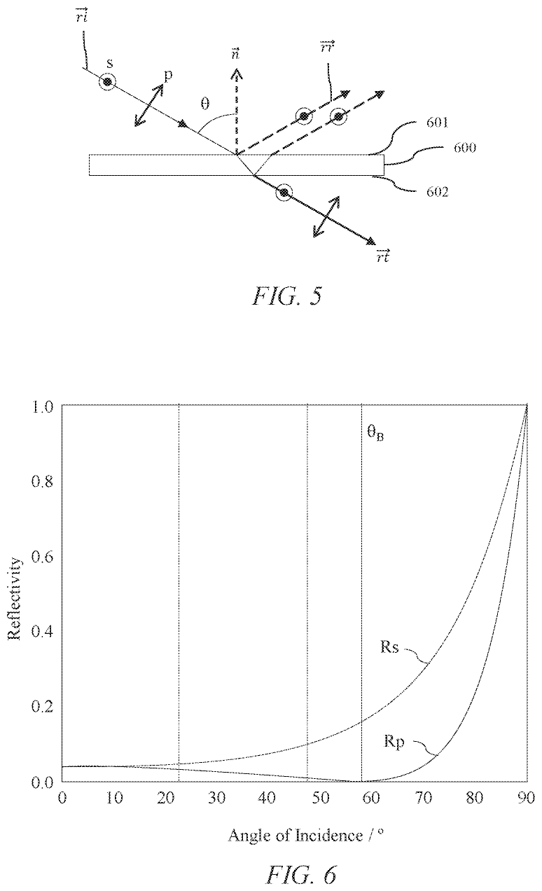

FIG. 6 is a graph of reflectivity of linearly polarised light from surfaces of a sheet of optically transmissive material with a refractive index of 1.5. The interaction of light with the surfaces 601 and 602 of the sheet of optically transmissive material 600 is significantly differently for the s-polarization component s and the p-polarization component p, in accordance with the Fresnel equations. By way of example, FIG. 6 shows the variation with angle of incidence θ of reflectivities Rs and Rp of a sheet of material 600 for the s-polarization component s and the p-polarization component p, respectively. As can be seen, the reflectivities Rs and Rp vary significantly, the reflectivity Rp of the p-polarization component p dipping by a significant amount below the reflectivity Rs of the s-polarization component, and reaching zero when the angle of incidence θ is at the Brewster angle θ_{B}.

The reflections are controlled by selecting the first and second optical retarders 801 and 802 in the display device 100 (or in the general case the or each optical retarder), using the following method. In this example, both reflections are reduced for the same viewer.

Returning to the description of FIG. 4, firstly a viewing position 44 is defined from where a viewer 45 is intended to view the display device 100. The viewing position 44 is a defined by a vector v relative to a predetermined point 105 on the display device 100, typically at the centre of the display device 100.

Next, there are identified first and second rays of light r1 and r2 output from the predetermined point 105 on the display device 100 and reflected from the first and second surfaces 610 and 612, respectively, to the common viewing position 44. For each of the first and second rays of light r1 and r2, there is identified the first and second points 613 and 614 at which the reflections on the first and second surfaces 611 and 612 occur. The first and second rays of light r1 and r2 are represented by the vectors from the predetermined point 105 on the display device 100 to the first and second points 613 and 614, respectively. The first and second normals n1 and n2 of the first and second surfaces 611 and 612 at the first and second points 613 and 614, respectively, are similarly identified.

Next, planes of incidence in respect of the first and second rays of light r1 and r2 are defined. Specifically, a first plane of incidence is defined in respect of the first ray of light r1 and the first normal n1 and a second plane of incidence in respect of a second ray of light r2 and the second normal n2.

For each of the first and second rays of light r1 and r2, a polarisation component in a direction perpendicular to the respective plane of incidence (s-polarisation component) and a polarisation component in a direction in the respective plane of incidence (p-polarisation component) may be defined.

In a vector representation, given reflection of a ray of light r from point on a surface at a point with a normal n, the s-polarisation component s is perpendicular to r and ns and so given by the equation:

$$s = \frac{( r \times n s )}{\vert ( r \times n s ) \vert} \qquad eqn . 4$$

Similarly, the p-polarisation component p is perpendicular to r and s and so given by the equation:

$$p = \frac{r \times ( r \times n s )}{\vert r \times ( r \times n s ) \vert} \qquad eqn . 5$$

Next the first and second optical retarders 801 and 802 are selected, having regard to the predetermined polarization state of the light output from the display device 100 so that the polarization state of the first ray of light r1 is caused to be linearly polarized in a direction that is in the first plane of incidence (i.e. p-polarised), and the polarization state of the second ray of light is to caused to be to be linearly polarized in a direction that is in the second plane of incidence (i.e. p-polarised). In the general case that the predetermined polarization states of the first and second rays of light r1 and r2 output from the display panel 101 are not already p-polarised, this involves the first and second optical retarders 801 and 802 transforming the polarization states of the first and second rays of light r1 and r2. However, in some specific cases one of the first and second rays of light r1 and r2 output from the display device 100 may already be p-polarised, in which case the first and second optical retarders 801 and 802 may be selected to have no effect on that ray of light.

This has the effect of causing both the first and second rays of light r1 and r2 to be p-polarised, thereby simultaneously minimising the amount of reflection from both of the first and second surfaces 611 and 612.

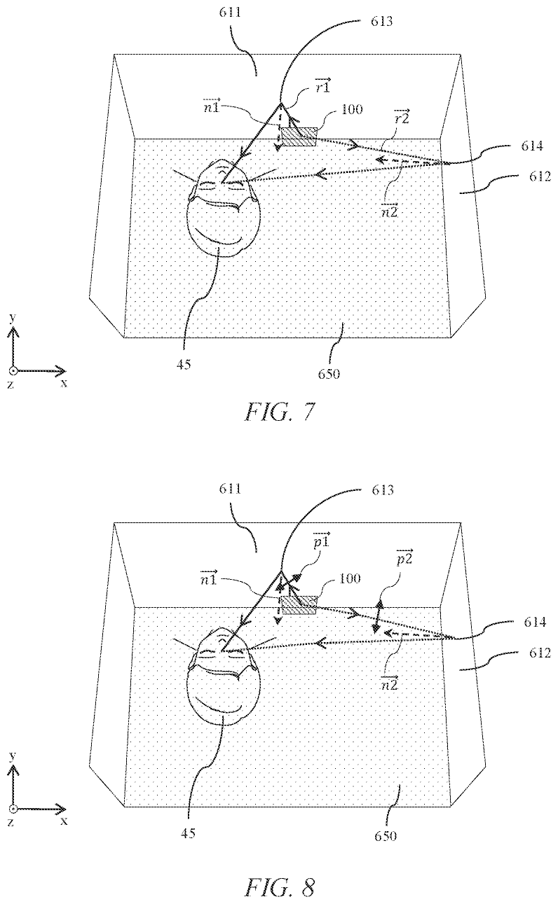

This is illustrated in FIGS. 7-8 which are perspective views of an example of the optical arrangement of FIG. 4 being a vehicle 650 in which the first surface 611 is the windshield of the vehicle 650 and the second surface 612 is a side window of the vehicle 650. FIG. 7 illustrates the first and second rays of light r1 and r2 output from the display device 100 and FIG. 8 the p-polarization states of the first and second rays of light r1 and r2.

Such selection of the first and second optical retarders 801 and 802 is possible because a desired polarization state for a particular ray of a particular wavelength can always be transformed from any input polarization state with an optical retarder whose optical axis and retardance are freely selected.

Introducing a temporal phase shift between polarization components cause their amplitudes to add at different times creating a temporally varying electric field direction thus transforming the linear state into a more general elliptical one. A retarder introduces a relative phase shift between components by selectively slowing down the polarization component aligned with its optical axis. A half-wave phase shift forces the original components to be completely out-of-phase resulting in a linear polarization state whose direction is the reflected original about the projection of the optical axis of the optical retarder.

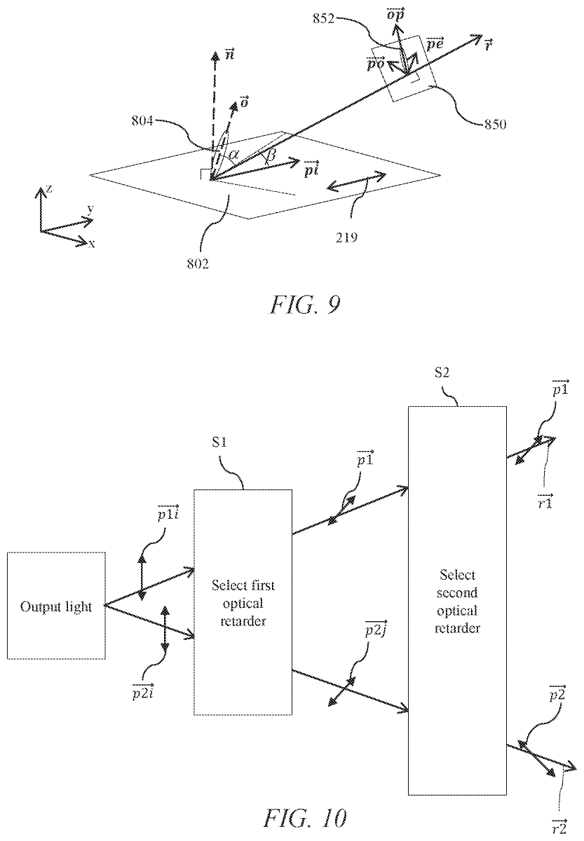

FIG. 9 is a perspective view of the second optical retarder 802 showing an example of how the polarisation state of a ray of light is controlled, as follows.

The second optical retarder 802 has an optical axis o which lies at an acute angle α to the plane of the second optical retarder 802. The electric vector transmission direction 219 of the output polariser 218 is shown and light output from the display device 100 along the normal n to the plane of the second optical retarder 802 is linearly polarised in a direction pi of linear polarisation that is parallel thereto. The projection of the direction of the optical axis o of the second optical retarder 802 onto the plane of the second optical retarder 802 has an azimuth angle β to the direction pi of linear polarisation.

A ray of light r output from the display device 100 is considered and a plane 850 normal to that ray of light r is shown. The ray of light r has an initial direction pe of linear polarisation which is the projection of the direction pi of linear polarisation onto the plane 850.

The projection 852 of the birefringent molecules 804 onto the plane 850 and the projection op of the optical axis o onto the plane 850 are also both shown. The second optical retarder 802 provides a phase shift that transforms the polarisation state of the ray of light r in accordance with the projection op of the optical axis o onto the plane 850. In this example, the second optical retarder 802 provides a half-wave retardance at a wavelength of 550 nm along the second ray of light r. In that case, the second optical retarder 802 transforms the polarisation state of the ray of light r by changing the direction of linear polarisation from the initial direction pe to a final direction po, wherein the projection op of the optical axis o onto the plane 850 bisects the initial direction pe and the final direction po. This is often referred to as a “rotation” of the direction of linear polarisation, although strictly speaking it is a transformation of the direction of linear polarisation through elliptical polarisation states.

Herein, all materials are assumed to have a refractive index of one for clarity of description. That is unrealistic, but the actual refractive indices may be accounted for by transforming the polarization states and ray directions at each interface, requiring extra but orthodox computation.

As a result, it is possible to select optical retarders to independently control the polarisation state of the first and second rays of light r1 and r2. In fact, there are an infinite number of such solutions since the optical axes of any one solution can have an arbitrary component along the direction of the ray. Mathematically this falls out of the three degrees of freedom possessed by an arbitrary optical retarder to provide the required two dimensional polarization manipulation.

By the same argument this restricts a uniaxial optical retarder to the arbitrary manipulation of the polarization state of no more than one ray, unless the polarization transformations of one of the rays requires less restriction on the optical retarder. Such a case occurs when a linear polarization state is retained for one of the rays. Here any retarder having no component orthogonal to both ray and preserved linear polarization directions may be selected. This reduced restriction frees up two degrees of freedom for an arbitrary transformation of a second ray. Recognizing this provides a general method of providing any polarization state for any two given rays using the general approach as follows.

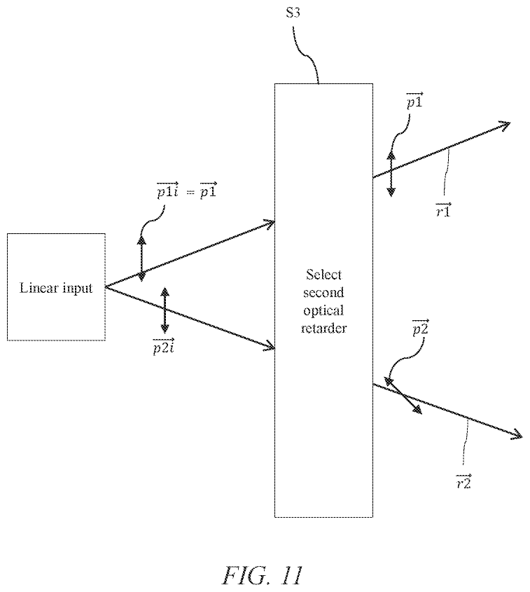

To maintain an original polarization state for certain rays while transforming others, it is possible to select an optical retarder to have an optical axis having different projected retarder orientations with respect to the initial polarization direction for the first and second rays of light r1 and r2. Maintaining the polarization of the first ray of light r1 in a given plane can be achieved by restricting the optical axis of the second optical retarder 802 to lie within that given plane. The angle of the optical axis of the second optical retarder 802 within that plane and the retardance of the second optical retarder 802 are then selected so that the projection of the optical axis onto the normal to the second ray of light r2 provides the desired transformation of the second ray of light r2. This will now be described in more detail with reference to FIGS. 10-11.

FIG. 10 is a chart illustrating a method for selection of the optical retarders in the display device 100 of FIGS. 1-2 including first and second optical retarders 801 and 802. This method is applicable in the case that the light output from the display device 100 has a predetermined polarization state of being linearly polarized in an arbitrary direction which is not in the first plane of incidence.

The first ray of light r1 output from the display device 100 has an initial polarisation state p1i and the second ray of light r2 output from the display device 100 has an initial polarisation state p2i.

In step S1, the first optical retarder 801 is selected to transform the direction of linear polarization of the first ray of light r1 that is present on output from the display panel 101 (initial polarisation state p1i) from into the first plane of incidence (p-polarisation state p1). As discussed further below, the second optical retarder 802 does not transform the direction of linear polarization of the first ray of light r1, so the first optical retarder 801 has the same properties whether before the second optical retarder 802 in the example of FIG. 1 or after the second optical retarder 802 in the example of FIG. 2.

Step S1 is performed by selecting the optical axis of the first optical retarder 801 to have a projection onto a plane normal to the first ray of light r1 which bisects (a) the direction of linear polarization of the first ray of light r1 output from the display device 100 and (b) the first plane of incidence.

The first optical retarder 801 has an optical axis parallel to the plane of the first optical retarder 801 and for optical retarders of this type, the optical transformation may be a good approximation to isotropic with angle for many common uniaxial materials. In such cases, selection of the first optical retarder 801 may be simplified by having regard merely to the transformation of a ray normal to the plane of the first optical retarder 801. In this case, the optical axis of the first optical retarder 801 may be selected to bisect (a) the direction of linear polarization of a normal ray of light output in a normal direction to the display device 100 and (b) the first plane of incidence.

Step S1 is also performed by selecting the first optical retarder 801 to provide a half-wave retardance at a design wavelength, typically of 550 nm, along the first ray of light r1. As discussed above with reference to eqn. 1, the retardance may be controlled by selection of the birefringence Δn and the thickness d of the first optical retarder 801. Where selection of the first optical retarder 801 is simplified by having regard merely to the transformation of a ray normal to the plane of the first optical retarder 801, then the first optical retarder 801 may similarly be selected to provide a half-wave retardance at the design wavelength along the normal to the first optical retarder 801.

In step S2, the second optical retarder 802 is selected to achieve the following effects.

The first effect is that the second optical retarder 802 does not transform the direction of linear polarization of the first ray of light r1 that is incident thereon. This effect is achieved by the second optical retarder 802 being selected to have an optical axis o which lies at an acute angle α, to the plane of the second optical retarder 802 and in a plane containing the first ray of light r1 and the direction of polarization of the first ray of light r1 that is incident on the second optical retarder 802. As a result of the optical axis o lying in this plane, the projection of the optical axis o onto plane normal to the first ray of light r1 is aligned with the direction of linear polarization of the first ray of light r1, so does not transform the polarisation state of the first ray of light r1.

However, the azimuth angle β of the optical axis o about the normal to the second optical retarder 802 depends on whether the second optical retarder 802 is before or after the first optical retarder 801.

In the case of FIG. 1 that the second optical retarder 802 is after the first optical retarder 801, then the polarisation state of the first ray of light r1 has been transformed into the first plane of incidence. Accordingly, in this case, the optical axis o of the second optical retarder 802 is arranged to lie in the first plane of incidence.

In the case of FIG. 2 that the second optical retarder 802 is before the first optical retarder 801, then the polarisation state of the first ray of light r1 remains in the initial polarisation state p1i of the first ray of light r1 output from the display panel 101. Accordingly, in this case, the optical axis o of the second optical retarder 802 is arranged to lie in a plane containing the first ray of light r1 and the direction of polarization of the initial polarisation state p1i.

The second effect is that the second optical retarder 802 transforms the direction of linear polarization of the second ray of light r2 that is incident thereon into a predetermined direction such that the first and second optical retarders 801 and 802 together transform the direction of linear polarization of the second ray of light r2 into the second plane of incidence.

The second effect of Step S2 is achieved by selecting the optical axis o of the second optical retarder 802 to have a projection onto a plane normal to the second ray of light r2 which bisects (a) the direction of linear polarization of the second ray of light r2 that is incident thereon, and (b) the predetermined direction.

The acute angle α between the optical axis o of the second optical retarder 802 and the plane of the second optical retarder 802 depends on whether the second optical retarder 802 is before or after the first optical retarder 801.

In the case of FIG. 1 that the second optical retarder 802 is after the first optical retarder 801, then the direction of linear polarization of the second ray of light r2 has already been transformed by the first optical retarder 801 before being incident on the second optical retarder 802, and the predetermined direction into which the direction of the linear polarisation is transformed is the final direction in the second plane of incidence. Accordingly, in this case the optical axis o of the second optical retarder 802 has a projection onto a plane normal to the second ray of light r2 which bisects (a) the direction of linear polarization of the second ray of light r2 after transformation by the first optical retarder 801 and (b) the second plane of incidence.

In the case of FIG. 2 that the second optical retarder 802 is before the first optical retarder 801, then the polarization state of the second ray of light r2 remains in the initial polarisation state p2i of the second ray of light r2 output from the display panel 101 and the predetermined direction is determined taking into account the subsequent transformation of the second ray of light r2 by the first optical retarder 801, i.e. such that the first optical retarder 801 transforms the predetermined direction of the linear polarization of the second ray of light r2 that is incident thereon into the second plane of incidence. Accordingly, in this case, the optical axis o of the second optical retarder 802 has a projection onto a plane normal to the second ray of light r2 which bisects (a) the direction of linear polarization of initial polarisation state p2i of the second ray of light r2 and (b) the predetermined direction so determined.

Step S2 is also performed by selecting the retardance of the second optical retarder 802 to provide a half-wave retardance at a design wavelength, typically of 550 nm, along the second ray of light r2.

FIG. 11 is a chart illustrating a method for selection of the optical retarders in the display device 100 of FIG. 3 including only the second optical retarder 802. This method is applicable in the case that the light output from the display device 100 has a predetermined polarization state of being linearly polarized in a direction in the first plane of incidence. In that case, the first optical retarder 801 is not needed, and the second optical retarder 802 may be selected in a similar manner to the method of FIG. 11.

Specifically, the method comprises a single step S3 in which the second optical retarder 802 is selected to achieve the following effects.

The first effect is that the second optical retarder 802 does not transform the direction of linear polarization of the first ray of light r1 that is output from the display panel 101 and incident thereon. This effect is achieved by the second optical retarder 802 being selected to have an optical axis o which lies at an acute angle α to the plane of the second optical retarder 802 and in the first plane of incidence. As a result of the optical axis o lying in the first plane of incidence, the projection of the optical axis o onto plane normal to the first ray of light r1 is aligned with the direction of linear polarization of the first ray of light r1, so does not transform the initial polarisation state p1i of the first ray of light r1.

The second effect is that the second optical retarder 802 transforms the direction of linear polarization of the second ray of light r2 that is output from the display panel 101 and incident thereon into the second plane of incidence. This is achieved by selecting the optical axis o of the second optical retarder 802 to have a projection onto a plane normal to the second ray of light r2 which bisects (a) the direction of linear polarization of the second ray of light r2 that is output from the display panel 101, and (b) the second plane of incidence.

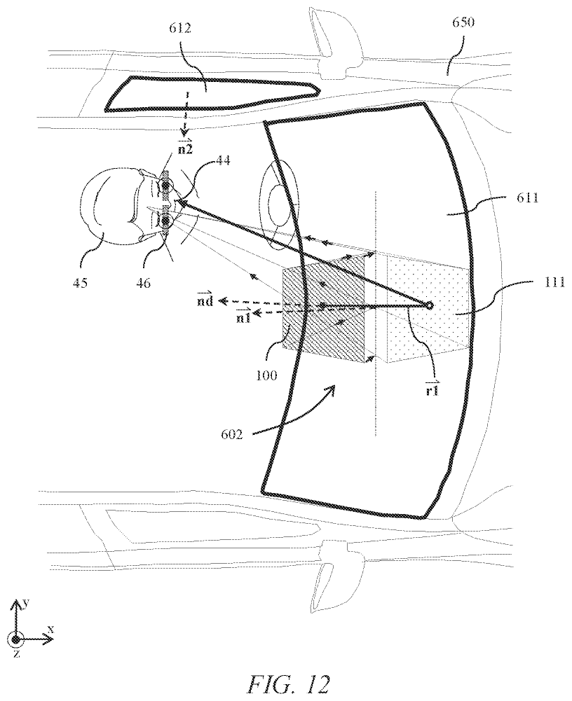

The methods shown in FIGS. 11-12 are examples and the first and second optical retarders 801 and 802 may be selected in other manners to provide the same effect. Moreover, the methods may be generalised to selection of the optical retarders for output light having any predetermined polarization state.

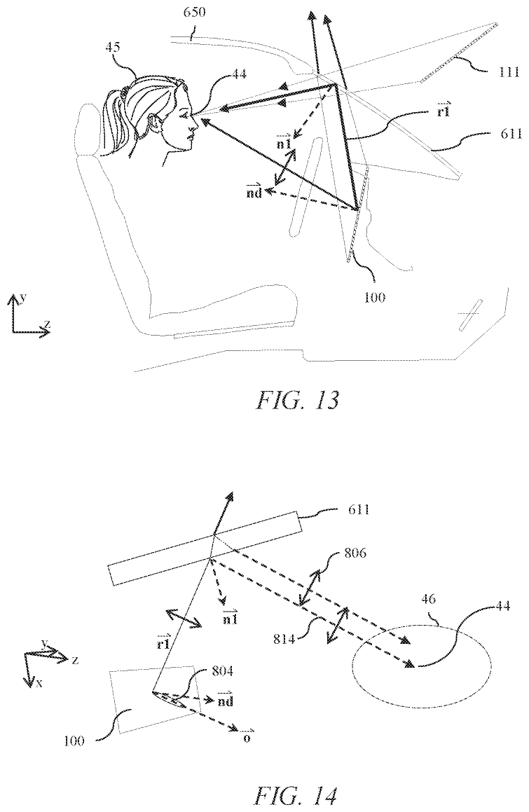

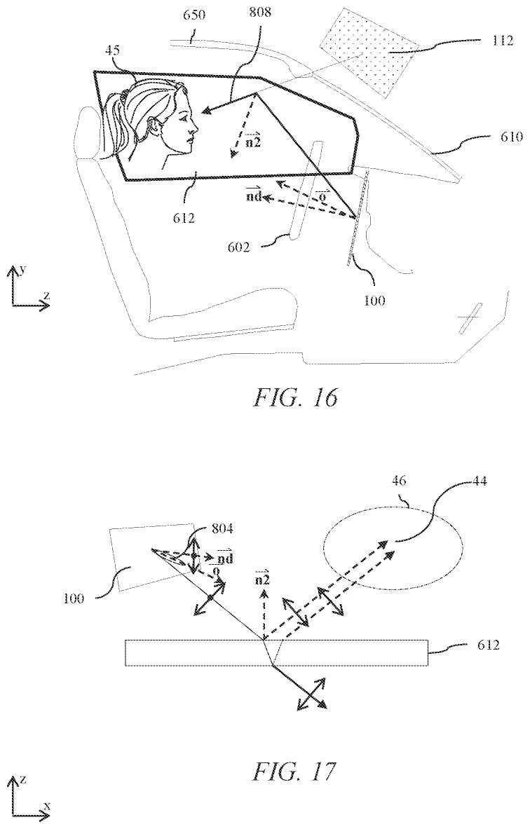

An example in which the optical arrangement of FIG. 4 is a vehicle 650 is shown in greater detail in FIGS. 12-17. Herein, the first surface 611 is the windshield of the vehicle 650 and the second surface 612 is a side window of the vehicle 650. The display device 100 is arranged in the dashboard 602 at a central position across the vehicle 650. Features of the embodiments of FIGS. 12-17 not discussed in further detail may be assumed to correspond to the features with equivalent reference numerals as discussed above, including any potential variations in the features.

FIGS. 12-14 illustrate the normal viewing position 44 of the viewer 45 who is the driver of the vehicle, and also a reflection from the first surface 611 (windscreen). In this example, the light output by the display panel 101 is linearly polarized in a vertical direction to match the transmission of anti-glare polarized glasses when worn by the driver 45. The first and second optical retarders 801 and 802 are selected to transform the polarization state of the first ray of light r1 to be in the first plane of incidence, which is close to vertical in this example. This minimizes reflections from the first surface 611 (windscreen) which would otherwise create an image 111 of the display device 100.

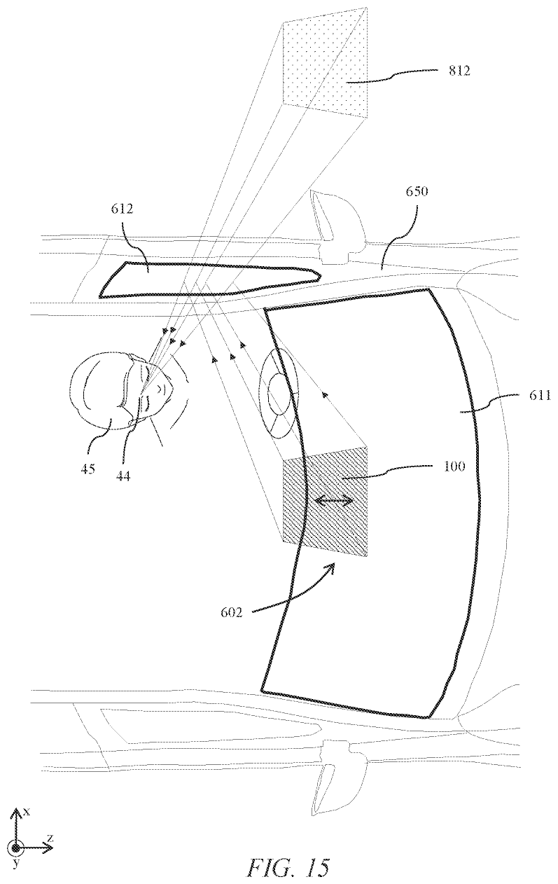

FIGS. 15-17 illustrate a reflection from the second surface 611 (side window). In this example, as the light output by the display panel 101 is linearly polarized in a vertical direction, then in the absence of the first and second optical retarders 801 and 802 this would be close to an s-polarisation state which would provide relatively large reflectivity, thereby creating an image of the display device 100. However, the first and second optical retarders 801 and 802 are selected to transform the polarization state of the second ray of light r2 to be in the second plane of incidence, which is close to horizontal in this example, thereby reducing these reflections. This minimizes reflections from the second surface 612 (side window) which would otherwise create an image 812 of the display device 100.

Although the display device 100 is configured to minimize reflections at a particular viewing position 44, in fact reflections are reduced by a similar amount across a typical viewing box 46 within which eyes of different drivers are expected to be located.

In all the above examples, the first and second rays of light r1 and r2 are reflected from the first and second surfaces 611 and 612, respectively, to a common viewing position 44. However, the first and second optical retarders 801 and 802 could be selected to reduced reflections of first and second rays of light r1 and r2 are reflected from first and second surfaces 611 and 612 to different locations. That might be useful in various applications, for example to reduce reflections perceived by two viewers in different locations. In this case, the method of selecting the first and second optical retarders 801 and 812 is the same, except for the first and second planes of incidence being differently defined.

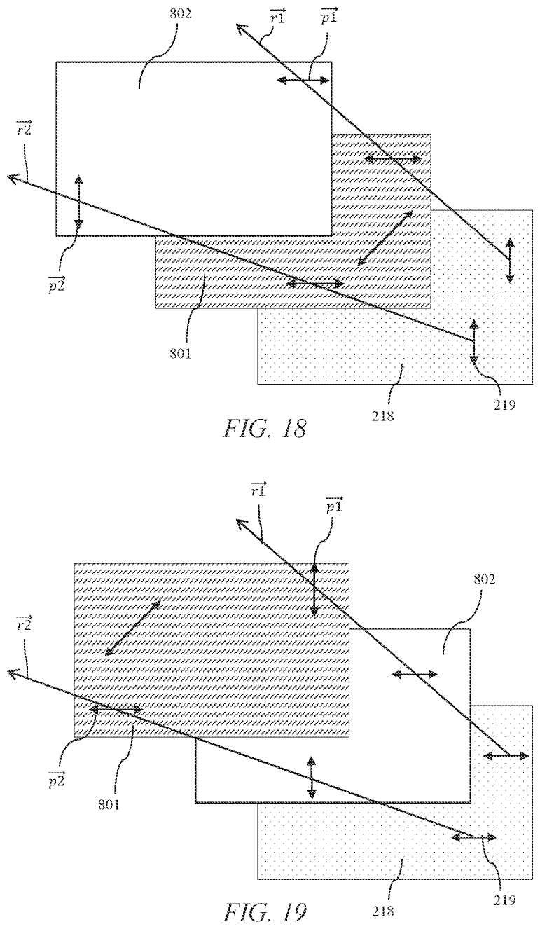

FIG. 18 is a front view of an example of the optical stack of the display device 100 of FIG. 1 in which the first optical retarder 801 is arranged before the second optical retarder 802, and illustrating the polarization states of the first and second rays of light r1 and r2. In this example, the electric vector transmission direction 219 is vertical, the first plane of incidence is horizontal and the second plane of incidence is vertical. Accordingly, the first optical retarder 801 is selected to transform the direction of linear polarization of the first ray of light r1 to be horizontal, and so also transforms the direction of linear polarization of the second ray of light r2 to be horizontal. Therefore, the second optical retarder 802 is selected to transform the direction of linear polarization of the second ray of light r2 from that horizontal direction to be vertical.

FIG. 19 is a front view of a second example of the optical stack of the display device 100 of FIG. 2 in which the first optical retarder 801 is arranged after the second optical retarder 802, and illustrating the polarization states of the first and second rays of light r1 and r2. In this example, the electric vector transmission direction 219 is horizontal, the first plane of incidence is vertical and the second plane of incidence is horizontal. Accordingly, the first optical retarder 801 is selected to transform the direction of linear polarization of the first ray of light r1 to be vertical and so will perform a predictable transformation of the second ray of light r2. Therefore, the second optical retarder 802 is selected to transform the direction of linear polarization of the second ray of light r2 from the horizontal direction to a predetermined direction which is vertical, so that the subsequent transformation of the second ray of light r2 by the first optical retarder 801 is from that vertical direction to horizontal direction.

The display device 100 may be of any type. Some non-limitative examples are as follows. The display panel 101 may be a simple instrument display panel. The display panel 101 may comprise a spatial light modulator (SLM). Such an SLM may be an emissive SLM, for example comprising light emitting diodes that may be organic (OLED) or inorganic (micro-LED) or combination of inorganic and organic. Alternatively, such an SLM may be a transmissive SLM, for example being an LCD display panel, in which case the display panel may further comprise a backlight arranged to illuminate the SLM.

Features of the embodiments of FIGS. 18-19 not discussed in further detail may be assumed to correspond to the features with equivalent reference numerals as discussed above, including any potential variations in the features.

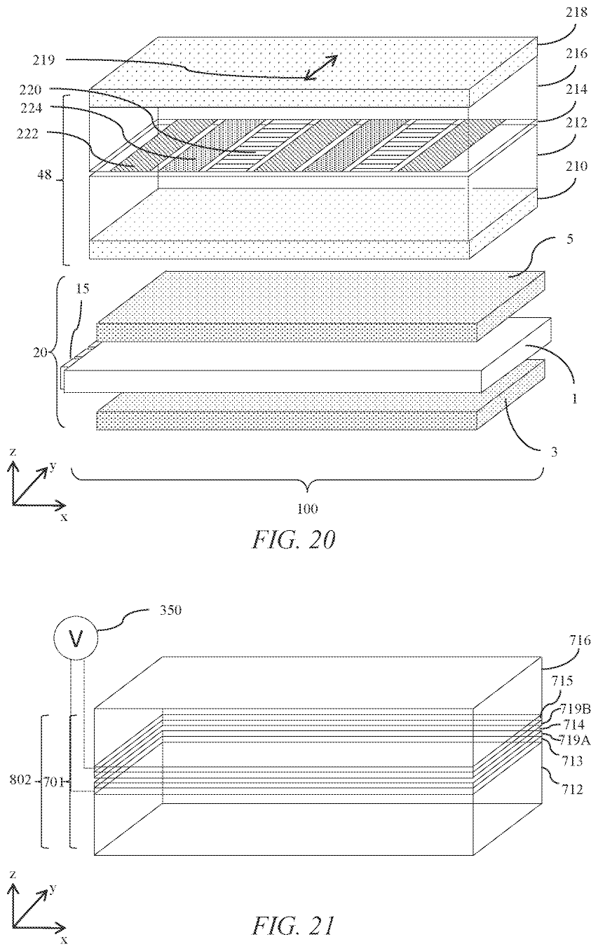

FIG. 20 is aside perspective view of an example of the display panel 101 in the display devices 100 of FIGS. 1-3 that comprises a transmissive SLM 48 and a backlight 20 arranged to illuminate the SLM 48.

The SLM 48 comprises comprise a liquid crystal display comprising substrates 212, 216, liquid crystal layer 214 and red, green and blue pixels 220, 222, 224. The SLM 48 further comprises an input polariser 210 arranged on the input side of the SLM 48, as well as the output polariser 218 arranged on the output side of the SLM 48. The input polariser 210 and the output polariser 218 are each linear polarisers.

The backlight 20 comprises input light sources 15, a waveguide 1, a rear reflector 3 and an optical stack 5 comprising diffusers, light turning films and other known optical backlight structures. Asymmetric diffusers, that may comprise asymmetric surface relief features for example, may be provided in the optical stack 5 with increased diffusion in the elevation direction in comparison to the lateral direction may be provided. Advantageously, image uniformity may be increased.

The first and second optical retarders 801 and 802 (or more generally all the optical retarders) may be of any type.

The second optical retarder 802 that has an optical axis out of the plane of the second optical retarder may have an optical axis that has a uniform direction through its thickness. Alternatively, the first optical retarder 802 may have an optical axis that is splayed through its thickness. For the sake of simplicity, the above description describes the effect of the first and second optical retarders 801 and 802 for the case that they have an optical axis that is uniform through their thickness. In the case that the optical axis is splayed through the thickness of the first and second optical retarders 801 and 802, the optical effect is more complex in that the effect of successive layers must be considered, but this may be modelled using conventional techniques that allow the first and second optical retarders 801 and 802 to be selected to provide the effects disclosed herein.

The first and second optical retarders 801 and 802 may be passive retarders or may be electrically switchable between at least two modes, in any combination. In the case that either or both of the first and second optical retarders 801 and 802 is electrically switchable, then they are selected to have the effects described herein in at least one of the electrically switchable modes. This allows the display device 100 to be switchable between different states, for example between two state which each provide control of different reflections, or between a states which do and do not provide control of reflections.

In one example, each of the first and second optical retarders 801 and 802 are passive retarders, for example being formed of cured liquid crystal material or stretched polymer films.

In another example, the first optical retarder 801 is a passive retarder and the second optical retarder 802 is electrically switchable between at least two modes.

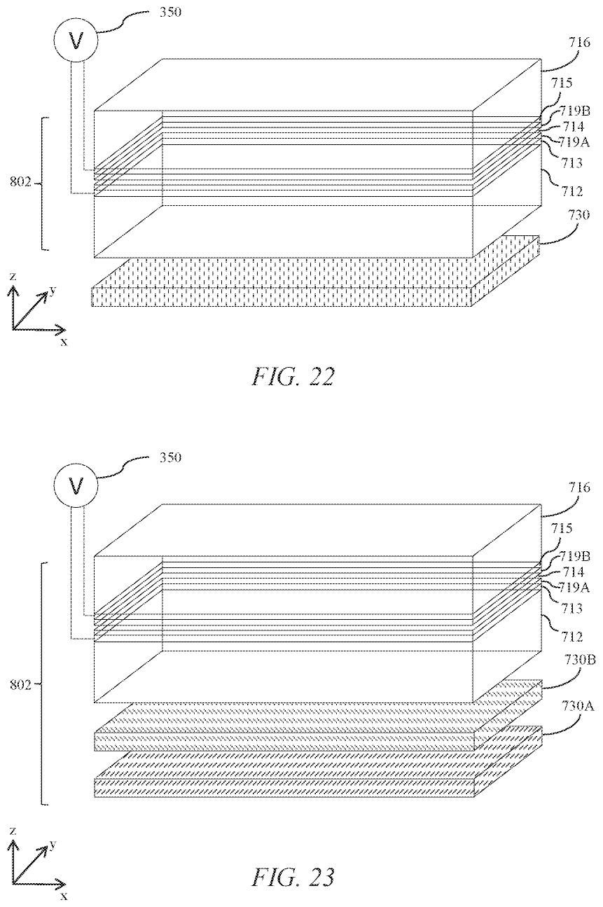

FIG. 21-23 side perspective views of three alternative examples of the second optical retarder 802 in the display devices 100 of FIGS. 1-3. In each example, the second optical retarder 802 have common elements as follows.

In each example, the second optical retarder 802 includes a layer 714 of liquid crystal material dispose between two substrates 712 and 716. The substrates 712 and 716 support respective electrodes 713 and 715 arranged to provide a voltage across the layer 714 of liquid crystal material for controlling the layer 714 of liquid crystal material. A control system 350 is connected to the electrodes 713 and 715, and is arranged to control the voltage applied thereacross.

The second optical retarder 802 also includes two surface alignment layers 719A and 719B disposed adjacent to the layer 714 of liquid crystal material and on opposite sides thereof. Each of the surface alignment layers 719A and 719B is arranged to provide alignment in the adjacent liquid crystal material, for example homeotropic alignment or homogenous alignment, for providing the second optical retarder 802 with appropriate properties.

In the example of FIG. 21, the second optical retarder 802 comprises no further retarder layers.

In the example of FIG. 22, the second optical retarder 802 comprises a passive retarder layer 730 having an optical axis perpendicular to the plane of the second optical retarder 802, i.e. a C-plate.

In the example of FIG. 23, the second optical retarder 802 comprises two passive retarder layers 730A and 730B that have optical axes in the plane of the second optical retarder 802 and crossed with respect to each other, i.e. crossed A-plates.

Other passive retarder layers may similarly be included in the second optical retarder 802. The use of such passive retarder layers allows the angular dependence of the retardance of the second optical retarder 802 to be adapted, for example to increase the range of angles over which a particular retardance is provided.

An illustrative embodiment of the arrangement of FIG. 23 will now be described.

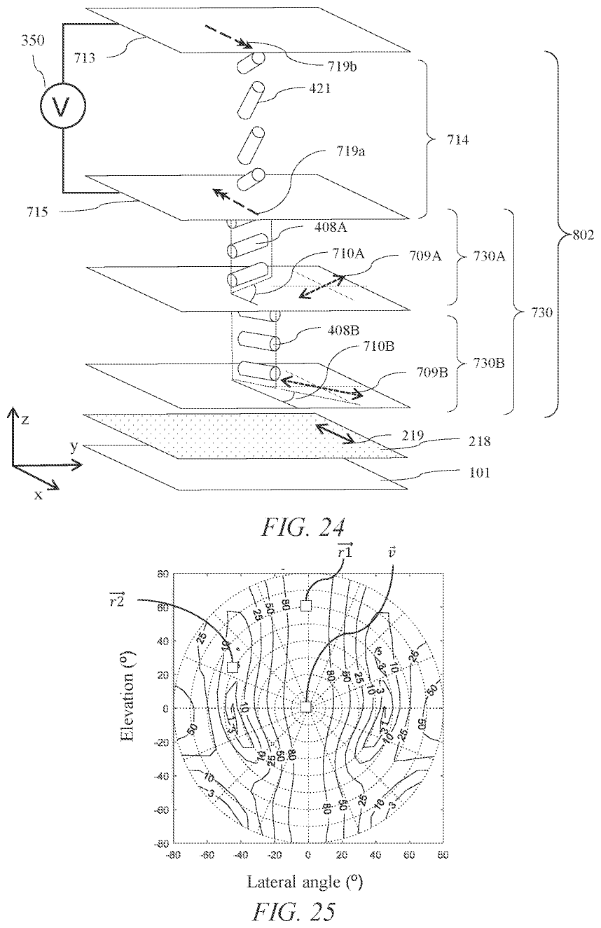

FIG. 24 is aside perspective view of the second optical retarder 802, output polariser 218 and display panel 101 of FIG. 23. View angle compensation retarder 730 comprises passive A-plates 730A, 730B that comprise birefringent molecules 408A, 408B. The optical axes 709A, 709B of A-plates 730A, 730B are arranged at angles 710A, 710B of +/45 degrees to the electric vector transmission direction 219 of the polariser 218. Active liquid crystal layer 714 comprises liquid crystal molecules 421 that may be driven to splayed state.

FIG. 25 is a graph illustrating the variation of luminance with polar direction for the second optical retarder 802 of FIG. 24. The operation of the passive retarders 730 and active retarder 714 in a driven state, output is shown with a further polarisation state analysing polariser provided to receive light from the second retarder 802. In operation, the further polarisation state analysing polariser is not provided, and is used here for illustrative purposes only. The polarisation state analysing polariser provides illustration of output operation by converting polarisation state transformation into a measurable luminance. Thus a high luminance in FIG. 25 illustrates a small polarisation transformation, and a low luminance illustrates a high polarisation transformation, that is a high retardance of the polariser at a given polar angle.

Polar locations of rays r1 and r2 are shown in an illustrative example for a display located in front of the driver and orthogonal first and second planes of incidence. In comparison to arrangements without passive retarders 730, the polar area over which desirable polarisation rotation may be increased. The size of the viewing box 46 for which desirable polarisation transformation is achieved may be increased. Advantageously freedom of driver or passenger location for reduced window reflections may be increased.

Viewing position vector v that in this illustrative example is on-axis is also provided with no polarisation transformation. Advantageously an observer wearing polarised sunglasses may see a high contrast, bright image.

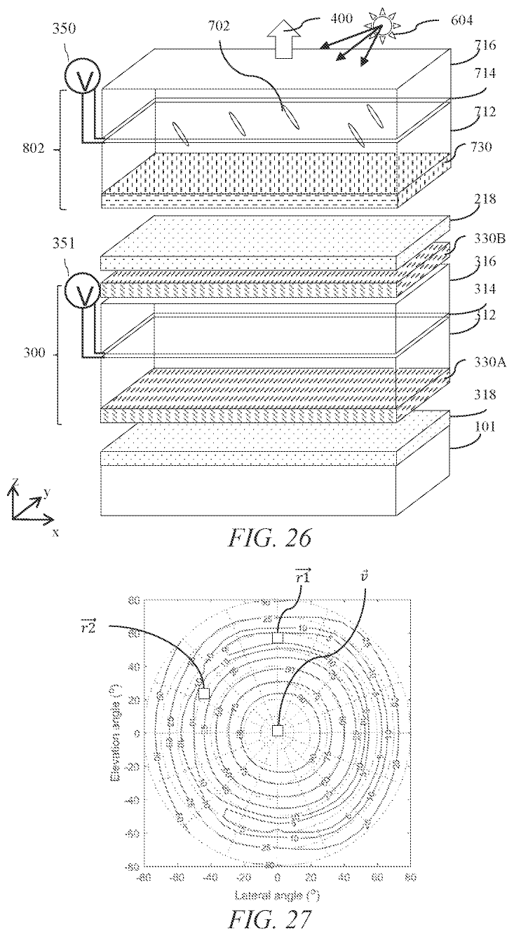

FIG. 26 is a perspective view of optical retarders that may be applied in the display panel 100 of FIG. 1. Features of the embodiment of FIG. 26 not discussed in further detail may be assumed to correspond to the features with equivalent reference numerals as discussed above, including any potential variations in the features.

Display panel 101 comprises additional polariser 318 and view angle luminance control retarder 300 arranged between the additional polariser 318 and output polariser 218. View angle luminance control retarder 300 comprises a layer 314 of liquid crystal material dispose between two substrates 312 and 316. The substrates 312 and 316 support respective electrodes (not shown) arranged to provide a voltage across the layer 314 of liquid crystal material for controlling the layer 314 of liquid crystal material. A control system 351 is connected to the electrodes, and is arranged to control the voltage applied thereacross.

The view angle luminance control retarder 300 also includes two surface alignment layers (not shown) disposed adjacent to the layer 314 of liquid crystal material and on opposite sides thereof. Each of the surface alignment layers is arranged to provide alignment in the adjacent liquid crystal material, for example homeotropic alignment or homogenous alignment, for providing the view angle luminance control retarder 300 with appropriate properties.

The view angle luminance control retarder 300 also comprises passive retarders. In an illustrative embodiment of FIG. 26, the passive retarders comprise quarter waveplates 330A, 330B arranged on opposite sides of the liquid crystal layer 314, and the layer 314 comprises a twisted liquid crystal material.

FIG. 27 is a graph illustrating the variation of luminance with polar direction for the view angle control retarder 300 of FIG. 26. The graph illustrates the polar variation of output luminance provided by the polarisers 218, 318. This is different to the polar variation of polarisation transformation illustrated in FIG. 25 in which for measurement purposes only an additional analysing polariser is provided.

In a driven state of the liquid crystal layer 314 the luminance profile is provided with a degree of rotational symmetry. Thus for the ray directions r1 and r2, the luminance is reduced. Comparing with FIG. 25, for light ray r1 the polarisation state is not transformed and the luminance is reduced and for light ray light ray r2 the polarisation state is transformed and the luminance is reduced. Advantageously light ray reflections from windscreen 610 and side window 612 are reduced by means of luminance reduction, and reduction of Fresnel reflectivity. For night operation, display reflection visibility is substantially reduced.

Viewing position vector v is also provided with minimal luminance reduction. Advantageously a bright image may be observed.

Switchable directional display apparatuses for use in privacy display for example and comprising plural retarders arranged between a display polariser and an additional polariser are described in U.S. Patent Publ. No. 2019-0086706, herein incorporated by reference in its entirety. Directional display apparatuses further comprising reflective polarisers arranged between the display polariser and retarders are described in U.S. Patent Publ. No. 2019-0250458, herein incorporated by reference in its entirety. Directional display polarisers comprising passive retarders arranged between a display polariser and an additional polariser are described in U.S. Patent Publ. No. 2018-0321553, herein incorporated by reference in its entirety.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1-23. (canceled)

24. A display device for a vehicle, the vehicle having first and second optically transmissive windows having first and second surfaces respectively, the display device comprising:
a display panel arranged to output light that has a predetermined polarization state,
an optical retarder arranged on the output side of the display panel,
wherein a first plane of incidence is defined in respect of a first ray of light output from the display device and a first normal to the first surface at a first point at which the first ray of light is reflected and a second plane of incidence in respect of a second ray of light output from the display device and a second normal to the second surface at a second point at which the second ray of light is reflected,
wherein the optical retarder is operable, in a mode of the optical retarder, to transform a polarization state of the first ray of light to a direction that is in the first plane of incidence, and the optical retarder is further operable to transform the polarization state of the second ray of light to a direction that is in the second plane of incidence.

25. The display device according to claim 24, wherein:
the predetermined polarization state is linearly polarized in a direction not in the first plane of incidence;
the optical retarder comprises first and second optical retarders, the first and second optical retarders being arranged in any order;
the first optical retarder is operable to transform the direction of linear polarization of the first ray of light that is present on output from the display panel into the first plane of incidence; and
the second optical retarder is operable to not transform the direction of linear polarization of the first ray of light that is incident thereon, and to transform the direction of linear polarization of the second ray of light that is incident thereon into a predetermined direction of linear polarization such that the first and second optical retarders together transform the direction of linear polarization of the second ray of light into the second plane of incidence.

26. The display device according to claim 25, wherein:
the second optical retarder is arranged on the output side of the first optical retarder; and
the second optical retarder is operable to not transform the direction of linear polarization of the first ray of light that is present after transformation by the first optical retarder and incident on the second optical retarder, and
the predetermined direction of linear polarization is in the second plane of incidence.

27. The display device according to claim 25, wherein:
the first optical retarder is arranged on the output side of the second optical retarder;
the second optical retarder is operable to not transform the direction of linear polarization of the first ray of light that is output from the display panel and incident on the second optical retarder, and
the predetermined direction of linear polarization is such that the first optical retarder transforms the predetermined direction of linear polarization of the second ray of light that is incident thereon into the second plane of incidence.

28. The display device according to claim 25, wherein the first optical retarder has an optical axis parallel to the plane of the first optical retarder.

29. The display device according to claim 28, wherein the optical axis of the first optical retarder has a projection onto a plane normal to the first ray of light that bisects (a) the direction of linear polarization of the first ray of light output from the display device and (b) the first plane of incidence.

30. The display device according to claim 28, wherein the optical axis of the first optical retarder bisects (a) the direction of linear polarization of a normal ray of light output in a normal direction from the display device and (b) the first plane of incidence.

31. The display device according to claim 29, wherein the first optical retarder provides a half-wave retardance at a wavelength of 550 nm along the first ray of light.

32. The display device according to claim 25, wherein the second optical retarder has an optical axis that lies at an acute angle to the plane of the second optical retarder and in a plane containing the first ray of light and the direction of polarization of the first ray of light that is incident thereon.

33. The display device according to claim 32, wherein the optical axis of the second optical retarder has a projection onto a plane normal to the second ray of light that bisects (a) the direction of linear polarization of the second ray of light that is incident thereon, and (b) the predetermined direction of linear polarisation.

34. The display device according to claim 33, wherein the second optical retarder provides a half-wave retardance at a wavelength of 550 nm along the second ray of light.

35. The display device according to claim 24, wherein the optical retarder comprises first and second optical retarders, the first optical retarder having an optical axis parallel to the plane of the first optical retarder, and the second optical retarder having an optical axis at an acute angle to the plane of the second optical retarder, the first and second optical retarders being arranged in any order.

36. The display device according to claim 25, wherein the first optical retarder is a passive retarder and the second optical retarder is an electrically switchable retarder that is switchable between at least two modes.

37. The display device according to claim 24, wherein:
the light output from the display panel is linearly polarized in a direction in the first plane of incidence,
the optical retarder is operable to not transform the direction of linear polarization of the first ray of light on output from the display panel, and
the optical retarder is operable to transform the direction of linear polarization of the second ray of light on output from the display panel into the second plane of incidence.

38. The display device according to claim 37, wherein the optical retarder has an optical axis that lies in the first plane of incidence at an acute angle to the plane of the second optical retarder.

39. The display device according to claim 38, wherein the optical axis of the second optical retarder has a projection onto a plane normal to the second ray of light which bisects (a) the direction of linear polarization of the second ray of light output from the display device, and (b) the second plane of incidence.

40. The display device according to claim 39, wherein the second optical retarder provides a half-wave retardance at a wavelength of 550 nm along the second ray of light.

41. The display device according to claim 24, wherein each optical retarder is a passive retarder.

42. The display device according to claim 24, wherein the optical retarder includes at least one electrically switchable retarder that is switchable between at least two modes.

43. The display device according to claim 24, wherein the first and second rays of light are reflected from the first and second surfaces, respectively, to a common viewing position.

44. A vehicle comprising:
a first optically transmissive window having a first surface;
a second optically transmissive window having a second surface; and
a display device comprising:
a display panel arranged to output light that has a predetermined polarization state,
an optical retarder arranged on the output side of the display panel,
wherein a first plane of incidence is defined in respect of a first ray of light output from the display device and a first normal to the first surface at a first point at which the first ray of light is reflected,
wherein a second plane of incidence is defined in respect of a second ray of light output from the display device and a second normal to the second surface at a second point at which the second ray of light is reflected,
wherein the optical retarder is operable, in at least one mode of the optical retarder, to transform a polarization state of the first ray of light to a direction that is in the first plane of incidence, and the optical retarder is further operable to transform the polarization state of the second ray of light to a direction that is in the second plane of incidence.
